(19) United States
(12) Patent Application Publication
(10) Pub. No.: US 2025/0196254 A1
(43) Pub. Date: Jun. 19, 2025

(54) LASER-INDUCED STRUCTURES FOR BIOMEDICAL USE

(71) Applicant: American Sterilizer Company, Mentor, OH (US)

(72) Inventors: Christophe Arnaud, Sainte-Anne-de-La-Pocatière (CA); Xavier Elie-Dit-Cosaque, Sainte-Brigitte-de-Laval (CA); Bruno Haas, Québec (CA); Philippe Labrie, Québec (CA); Luca Serli, Boischatel (CA)

(21) Appl. No.: 19/066,981

(22) Filed: Feb. 28, 2025

Related U.S. Application Data
(63) Continuation-in-part of application No. PCT/US2024/034627, filed on Jun. 19, 2024.
(60) Provisional application No. 63/559,656, filed on Feb. 29, 2024.
(60) Provisional application No. 63/509,081, filed on Jun. 20, 2023.

(51) Int. Cl. B23K 26/04; C23C 22/46

(52) U.S. Cl. CPC B23K 26/04; C23C 22/46

(57) ABSTRACT

A method for treating a metal substrate includes generating a beam from a single laser having a pulse duration less than 800 femtoseconds and a wavelength greater than 700 nanometers. The beam is split via a diffractive optical element to establish first and second separated beams angled away from each other. An optical prism alters respective pitches of the separated beams, and a focal lens receives the altered beams to angle them toward each other at or near a single focal point on the metal substrate. The combined laser irradiation from the altered, separated beams affects the metal substrate to concurrently form a plurality of microstructures and nanostructures thereon.

### CLAIM OF PRIORITY

This application is a continuation-in-part of WIPO PCT Application Serial No. PCT/US2024/034627, filed on Jun. 19, 2024, which claims the benefit of priority of: (1) U.S. provisional Application Ser. No. 63/509,081, filed on Jun. 30, 2023; and (2) U.S. provisional Application Ser. No. 63/559,656, filed on Feb. 29, 2024, each of which is hereby incorporated herein by reference, and the benefit of priority of each of which is claimed herein.

### STATEMENT REGARDING JOINT RESEARCH AND DEVELOPMENT

The present subject matter was developed and the claimed invention was made by or on behalf of STERIS, by STERIS and a third party, pursuant to a joint research agreement that was in effect on or before the effective filing date of the claimed invention, and the claimed invention was made as a result of activities undertaken within the scope of the joint research agreement.

### BACKGROUND

In biomedical engineering, the modification of material surfaces to augment their properties is of interest for crafting medical devices and systems. Stainless steel, such as for its robustness and corrosion resistance, can be used in various biomedical applications including surgical tools and wash stations. The surface properties of stainless steel can significantly influence its interaction with biological environments.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1A illustrates various examples of laser treated stainless steel substrates.

FIG. 1B illustrates electron microscope views of corresponding stainless steel substrates from FIG. 1A.

FIG. 1C shows a liquid droplet on a stainless steel substrate before and after a passivation of a surface of the laser treated substrate.

FIG. 2A illustrates an example of a system for laser induction of structures on a target substrate.

FIG. 2B illustrates an example of a system for laser induction of structures on a target substrate at a relatively high pitch.

FIG. 2C illustrates an example of a system for laser induction of structures on a target substrate at a relatively low pitch.

FIG. 3A illustrates an electron microscope view of a laser-induced nanopattern on an exemplary stainless steel substrate.

FIG. 3B illustrates an electron microscope view of a laser-induced nanopattern on an exemplary stainless steel substrate.

FIG. 3C illustrates an electron microscope view of a laser-induced nanopattern on an exemplary stainless steel substrate.

FIG. 3D illustrates an electron microscope view of a laser-induced nanopattern (NP) on an exemplary stainless steel substrate.

FIG. 4A illustrates an electron microscope view of a nanotextured surface of an exemplary stainless steel substrate.

FIG. 4B illustrates an electron microscope view of a nanotextured surface of an exemplary stainless steel substrate.

FIG. 4C illustrates an electron microscope view of a nanotextured surface of an exemplary stainless steel substrate.

FIG. 4D illustrates an electron microscope view of a nanotextured surface of an exemplary stainless steel substrate.

FIG. 5A is a chart showing a relationship between contact angle and laser induced periodic surface structure (LIPSS) overlap.

FIG. 5B is a chart showing a relationship between contact angle and laser induced periodic surface structure (LIPSS) shots per area.

FIG. 6A illustrates an electron microscope view of a microtextured and nanotextured surface of an exemplary stainless steel substrate.

FIG. 6B illustrates an electron microscope view of a microtextured and nanotextured surface of an exemplary stainless steel substrate.

FIG. 7 is a flowchart showing an example of a protocol for passivation of a stainless steel surface.

FIG. 8A illustrates an example of a laser-induced stainless steel surface prior to passivation.

FIG. 8B illustrates an example of a laser-induced stainless steel surface following a passivation protocol.

FIG. 9 is a flowchart describing an example of a process for treating a stainless steel substrate including laser-induced structures.

FIG. 10 illustrates generally an example of a block diagram of a machine.

### DETAILED DESCRIPTION

This document relates to the modification of stainless steel surfaces for biomedical applications using laser technology. Certain approaches can alter surface properties of stainless steel, such as chemical etching, mechanical polishing, and coating applications, to improve antibacterial properties or promote biocompatability. Certain approaches, however, can involve challenges of uneven surface modifications, potential contamination from coatings, or insufficient durability under biomedical operational conditions.

Certain laser texturing approaches can similarly be used to modify the surface characteristics of materials, such as stainless steel. Such modifications can alter properties such as wettability, which is the degree to which a liquid can maintain contact with a solid surface. The manipulation of surface textures at micro or nano scales using laser technology can help establish specified surface interactions without altering the inherent properties of the base material. One approach to laser texturing of materials involves short-pulse lasers to create micro-scale textures. These textures can help reduce bacterial adhesion by modifying the surface roughness or by inducing thermal effects that result in beneficial oxide layers. However, it can be challenging to achieve a consistent texture depth across a surface and to avoid damage the underlying material structure due to the thermal effects.

The present inventors have recognized the benefits of an improved technique for laser texturing of a material, by use of a dual-stage laser texturing process that can induce both microstructures and nanostructures on the surface of the material. Such a technique can involve a combination of different laser settings to first create microstructures and then superimpose nanostructures thereon. Such “hierarchical” texturing approach can help improve surface properties of the material, such as stainless steel, for biomedical applications, particularly enhancing hydrophobicity and antibacterial characteristics. In an example, the technique can involve an application of laser irradiation to form microstructures on the stainless steel surface. Such microstructures can be induced at specified depths and widths such as to help improve physical properties (e.g., mechanical grip or initial bacterial attachment). Such microstructures can provide a foundational layer for further nanostructuring thereupon. In an example, concurrent with the creation of microstructures, the application of laser irradiation can further be employed to form nanostructures. Such structures can be significantly smaller and tailored to fine-tune the surface properties, such as wettability and bacterial repellence. The nanostructures can contribute to establishing a surface that mimics natural antibacterial surfaces through physical pattern effects. For example, certain nanotextured surfaces can resemble adhesion properties of Human Mesenchymal Stem Cells (hMSCs) particularly in the case of Laser-Induced Periodic Surface Structures (LIPSS), nano-pillars, and spikes. Additionally, laser-induced textures can matrix mineralization and the formation of bone-like nodules. Using certain beam-split approaches described herein, a single laser beam can be used to affect a metal substrate to create both microstructures and nanostructures concurrently can provide certain advantages. For example, such beam-split approaches can help mitigate undesired thermal altering of the surface of the metal substrate, such as to avoid creating melted deposits of metal from the laser irradiation.

In an example, after the texturing processes, the stainless steel can undergo passivation. Such passivation can help stabilize the stainless steel, such as by accelerating formation of a natural oxide layer otherwise formed via aging of the stainless steel. For example, the oxide layer via the passivation can alter a surface property of the stainless steel from hydrophilic to hydrophobic. Such an alteration can be significant for biomedical applications where reduced water affinity can lead to lower bacterial adhesion and biofilm formation as well as general contamination (self-cleaning properties). In an example, the passivation or a similar process can be recurringly performed over time, involving the application of specific passivation agents and controlled heating processes. Recurring passivation can help ensure the longevity of the surface modifications under operational conditions. This detailed approach to surface texturing allows for a controlled, repeatable modification of stainless steel surfaces, providing significant advantages over traditional methods. The dual-texturing technique not only improves the immediate surface properties but also promotes durability and effectiveness in challenging biomedical environments.

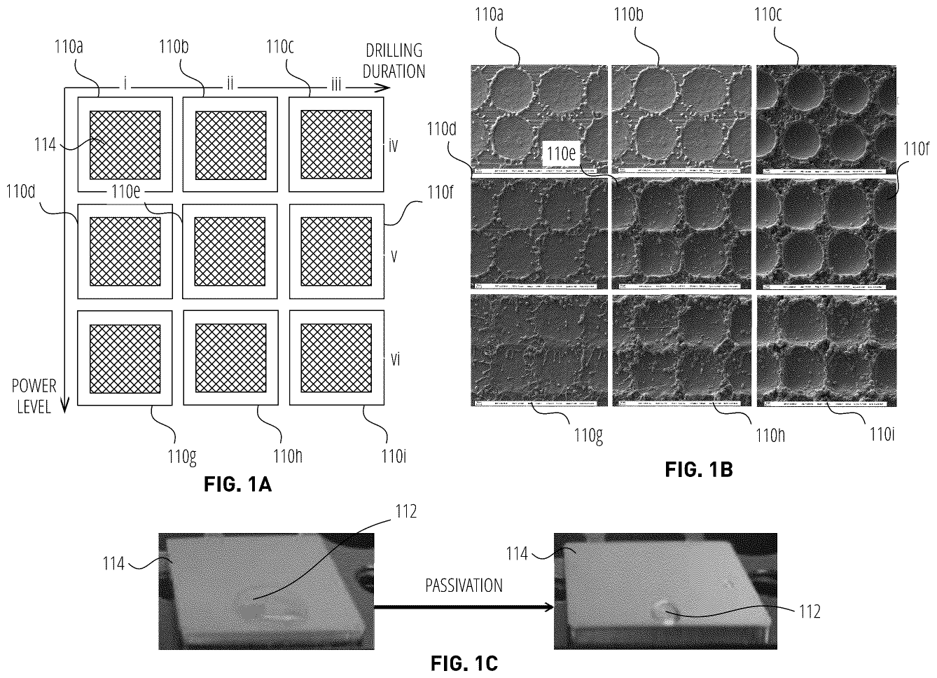

FIG. 1A illustrates examples of stainless steel substrates having various laser induced structures. FIG. 1B shows electron microscope views of corresponding stainless steel substrates from FIG. 1A. Laser-induction of structures (e.g., microstructures or nanostructures by engraving or otherwise inducing small cavities with a depth of a only few micrometers) to establish a textured surface 114 of an individual metal substrate 110, via the laser, can ultimately help reduce bacterial adhesion onto stainless steel. This can result in a formation of a thin layer of iron oxide, which can act as a local electrostatic repulsive and can help reduce Escherichia coli (E. coli) adhesion onto the surface 114. For example, such cavities can have diameters greater than 10 μm, and thermal effects of relatively short pulses (e.g., several nanoseconds) can help create an oxide layer. In one approach to laser-induction of microstructures, the laser can be pulsed laser, such as from a within a femtosecond range laser beam diffracted in two beams of equal energy, refocused at a certainn focal distance in order to obtain Direct Laser Interference patterns (DLIP) to establish an antibacterial and/or self-cleaning surface 114 on the metal substrate. By affecting the metal substrate 110 based on a hole-like pattern of a few micrometers, e.g., without a significant thermal effect on the substrate 110, about a 30% reduction in E. coli adherence can be achieved. In an approach to laser-induction of nanostructures, certain devices described herein can produce a split beam, the resulting beamlets kept parallel and refocused to hit the substrate at a specified angle. The beamlets' respective energies can interfere with each other, such as overlapping to create waves of interference resulting in DLIP on the substrate 110. Such DLIP can exhibit a line interference pattern with a period between hundreds of nanometers (nm) to tens of micrometers (e.g., about 850 nm), can affect the metal structure to create cone or hole patterns. Such an approach can involve a reduction in adherence to the substrate 110 of 99% for E. coli and over 70% for Staphylococcus aureus. Such effectiveness in producing antibacterial properties can be attributed to a limited number of contact points available for bacterial cells with dimensions ranging from 500 nm to 2000 nm. Further approaches to laser-induction of nanostructures can involve an ultrashort (e.g., <1 nanosecond (ns)) pulsed laser to achieve non-ablative texturing, e.g., resulting in the creation of surface plasmons. Nanostructures, such as patterns produced by Direct Laser Interference Patterning (DLIP), with their sub-micrometer sizes, can significantly reduce adherence of both E. coli and S. aureus (e.g., >99% and >84%, respectively), as opposed to simply polished surfaces and >1 micrometer spikes which can actually increase E. coli adherence.

Augmenting of the metal substrate 110, e.g., via laser (e.g., an infrared laser) to imprint cavities onto the metal substrate 110, can induce functional surfaces and significantly improve biomedical applications, wear resistance, and hardness of the metal substrate 110. While generally described herein as being formed of stainless steel, the metal substrate 110 can include such as titanium, cobalt-chromium alloys, molybdenum, chromium, iron, tantalum, or their alloys. In an example, the metal substrate 110 can be formed of 316L brushed stainless steel (finish number 4), such as having dimensions of about 20 mm×about 20 mm and having a thickness of about 1.6 mm. In an example, a plurality of metal substrates 110a, 110b, 110c, 110d, 110e, 110f, 110g, 110h, and 110i can each include the textured surface 114 including laser-induced structure. By applying differing parameters of the laser, such as differing drilling durations, different pitches, and different power levels, differing laser-induced surface structures can result. For example, column (i) (metal substrates 110a, 110d, and 110g), column (ii) (metal substrates 110b, 110e, and 110h), and column (iii) (metal substrates 110c, 110f, and 110i) can have progressively greater drilling durations. In an example, the metal substrates 110 in column (i) can be affected via the laser at a drilling duration of about 0.05 ms, the metal substrates 110 in column (ii) can be affected via the laser at a drilling duration of about 0.15 ms, and the metal substrates 110 in column (iii) can be affected via the laser at a drilling duration of about 0.25 ms. Also, row (iv) (metal substrates 110a, 110b, and 110c), row (v) (metal substrates 110d, 110e, and 110f), and row (vi) (metal substrates 110g, 110h, and 110i) can be affected via the laser at progressively greater power levels. In an example, the metal substrates 110 in row (iv) can be affected via the laser at a power level of about 60 watts (W), the metal substrates 110 in row (v) can be affected via the laser at a power level of about 80 W, and the metal substrates 110 in row (vi) can be affected via the laser at a power level of about 100 W.

In an example, differing pulse energies and drilling times applied to the metal substrates 110 can induce different colorization among the substrates 110, e.g., due to oxidation on the treated surface or light reflection patterns. Also, increasingly deeper cavities and larger melted metal projections zones can be correlated with higher power levels. In an example, a preferred laser-treated metal substrate 110 can be characterized by a minimal presence of melting or deep, rounded cavities (e.g., as shown in the exemplary metal substrate 110i in FIG. 1B). For example, such a preferred laser-treated metal substrate 110 can be prepared by affecting the substrate 110, via the laser, at a relatively low drilling time (e.g., within a range of about 0.05 ms to about 0.10 ms) and at a laser power level less than about 80 W (for example, substrate 110a and substrate 110d as depicted in FIG. 1B). Laser treatment of a metal substrate according to such parameters can induce cavities in the metal substrate 110 having a depth within a range of about 1.7 micrometers (μm) to about 6.5 μm. For example, such parameters can establish cavities in the substrate 110 exhibiting a spherical shape with smooth and a reduced occurrence of melting as compared to, e.g., substrates treated with greater power levels or longer drilling durations.

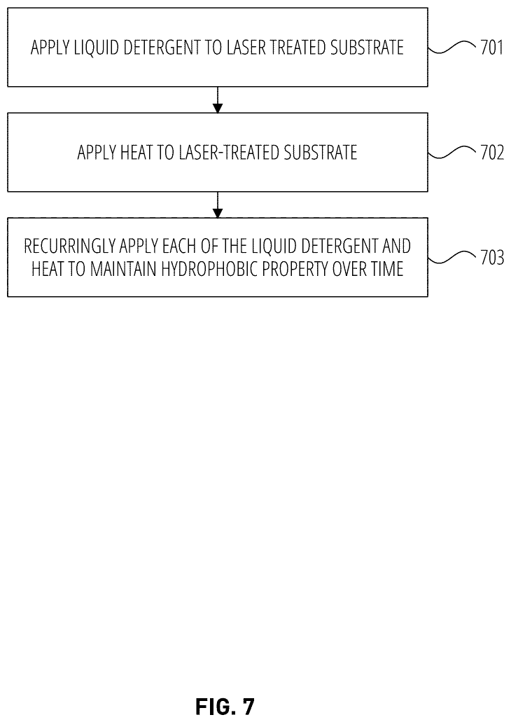

FIG. 1C shows a liquid droplet on a stainless steel substrate before and after a passivation of a surface of the substrate. In an example, following the affecting via the laser, the metal substrates 110 can exhibit hydrophilic properties on respective textured surfaces 114 (as depicted in FIG. 1C). Where an individual metal substrate 110 is subject to ambient conditions for days after the laser treatment, a thin oxide layer can form on the surface 114, resulting in a shifting toward a hydrophobic property of the surface 114 (as depicted in FIG. 1C). As described herein, the term “hydrophilic” means a contact angle below about 30°, “hydrophobic” means a contact angle within a range of about 60° and about 145°, and “superhydrophobic” means a contact angle greater than about 145°.

Where a laser has been used to imprint cavities onto a metal substrate 110 (as shown in FIG. 1B), the substrate 110 can exhibit increased wear resistance and hardness can by promoting formation of an oxide, such as by providing a relatively longer treatment time. Alternatively or additionally, Chemical Vapor Deposition (CVD) can be promoted such as to generate a superhydrophobic surface 114 on the metal substrate 110 via a combination of microstructures and nanostructures. For example, a surface 114 that has been affected via a laser to establish both microstructures and nanostructures can be subjected to passivation or exposed to ambient conditions leading to a growth of hydrocarbons and oxidized metal species on the surface 114 (e.g., within about 60 days of treatment at the ambient conditions). Such a phenomenon can be particularly characteristic of surfaces 114 including DLIP treatment. As a consequence of such a change in properties of the surface, a wettability of the surface 114 can shift from hydrophilic toward superhydrophobic. Further treatment techniques to promote passivation of a surface 114 of a laser treated metal substrate 110 are discussed below with respect to FIG. 7.

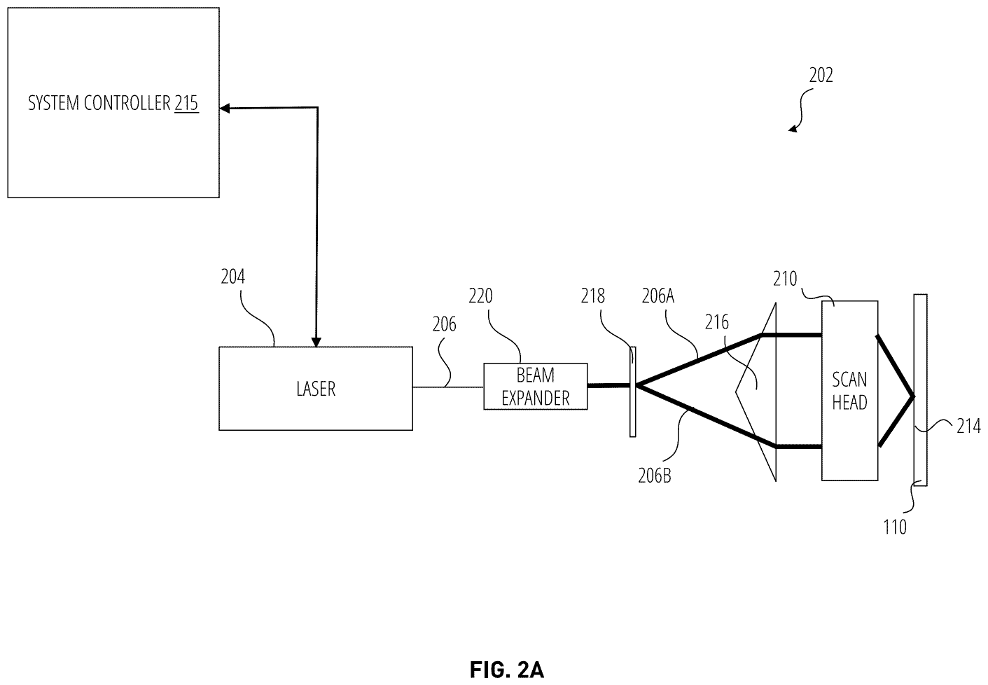

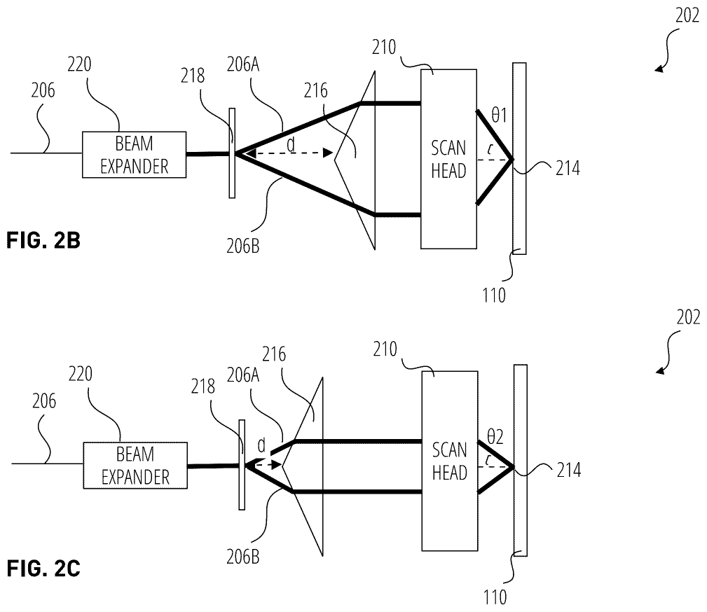

FIG. 2A, FIG. 2B, and FIG. 2C each illustrate an example of a system for laser induction of structures on a target substrate. The system 202 can include a laser 204, a beam expander 220, a diffractive optical element (DOE) 218, an optical prism 216, scanhead 210, and a system controller 215. In an example, the laser 204 can include a laser source configured to produce a laser beam. In an example, the system 202 can facilitate a production of bionic (e.g., mimicking a biological property), self-cleaning, antibacterial surfaces, e.g., via a multiple-beam interference pattern onto a metal substrate 110, e.g., via direct laser interference patterning (DLIP). Such laser treatment of a surface 114 the substrate 110 can facilitate formation of DLIP patterns. Such DLIP patterns can be produced (e.g., in a crossed pattern or at a specified angle) to induce a micro-pillar array including both microstructures and nanostructures, such as originating from a single laser 204. A resulting surface on the substrate 110 can include a superhydrophobic property, such as establishing a contact angle greater than 70° at the surface 114.

In an example, the laser 204 is a femtosecond laser, e.g., an NKT AeroPulse fs-AOM 20 W near infrared femtosecond laser, and can produce a beam having a pulse duration less than 800 femtoseconds and a wavelength greater than 700 nanometers (nm). For example, the femtosecond laser can produce a wavelength greater than about 1000 nm (e.g., about 1030 nm or about 1053 nm) and a pulse duration less than about 1000 femtoseconds (e.g., less than about 500 fs, such as about 450 fs). In an example, the beam 206 produced by the laser 204, such as having a collimated beam at an original diameter of about 0.5 millimeters (mm). A beam 206 from the laser 204 can be received by the beam expander 220, which can increase the diameter of the beam 206 while maintaining its original collimation. For example, the beam expander 220 can increase the diameter of the beam 206 to greater than about 2 mm and less than about 10 mm, such as about 5 mm, prior to the beam 206 entering the DOE 218. The DOE 218 can split the single beam 206, received from the beam expander 220, into separated beams 206A and 206B. In an example, the separated beams 206A and 206B can each be split at an angle greater than about 7°, (e.g., at an angle of about) 9.85° relative to the original beam angle. In an example, the DOE 218 can be a material produced by Holo/Or, e.g., ref. DS-033-J-Y-A.

The separated beams 206A and 206B can be received by the optical prism 216. In an example, the optical prism 216 can alter a pitch of each of the separated beams 206A and 206B (also referred to herein as “beamlets”) such that they are at least approximately parallel, such as essentially exactly parallel to each other. For example, the optical prism 216 can revert the angle of each of the beams 206A and 206B to approximately the same angle of the original beam exiting the beam expander 220. In an example, the optical prism 216 can be formed of fused silica and coated with an anti-reflective coating. In an example, the optical prism can be fused silica and can exhibit a refractive index within a range of about 1.2 and about 1.6, such as a refractive index of about 1.44962 at a wavelength of about 1030 nm. In an example, the optical prism 216 can have a largest angle (i.e., the angle opposite the longest triangular side of the prism 216) within a range of about 140° to about 180°, within a range of about 150° to about 170°, such as a largest angle of about 158.57°. After passing through the optical prism 216, the separated beams 206A and 206B can be received by the scanhead 210. The scanhead can include a focal lens (e.g., exhibiting about 70 millimeters (mm) focal length) to angle the separated beams 206A and 206B toward each other, e.g., to combine the beams at or near a single focal point on the surface 114 of the metal substrate 110. Such a combination of beams can generate interferential “striping” on the substrate 110, and the increment of such striping can be manipulated based on by the incidence angle of the beams received by the scanhead 210. For example, the separated beams 206A and 206B can be received by the scanhead as parallel, and the distance between the beams 206A and 206B can vary, resulting in different angles after the focal lens. As shown in FIG. 2B and FIG. 2C, a distance d between the optical prism 216 and the DOE 218 can be altered such as to specify an ultimate pitch (e.g., 01 and 02 shown in FIG. 2B and FIG. 2C, respectively) at which the separated beams 206A and 206B combine. For example, the optical prism 216 can be mounted to a prism manipulator (e.g., a slide, a gantry, an articulating arm, etc.) for adjusting the distance (d) between the optical prism and the DOE, and the prism manipulator can be user-controllable (e.g., via a handle, lever, or electronic control/user interface with the system controller 215).

An interval of microstructures produced on the metal substrate 110 can be approximately equal to the ultimate pitch, and as such the microstructure interval can be adjusted (e.g., within a range of about 2 micrometers μm to about 20 μm, about 5 μm to about 15 μm, about 6 μm and about 8 μm, such as approximately 7.3 μm intervals. The resulting combination of the separated beams 206A and 206B can induce DLIP on the surface 214 of the metal substrate 110, which can create both microstructures and nanostructures using a single laser as a starting point. For example, such microstructures can include an overlay of nanostructures of at least one of a laser induced periodic surface structure (LIPSS) or triangular nano-pattern (TNP) type. In an example, the nanostructures can be adjusted based on a wavelength of the beam 206 (e.g., to produce nanostructures within a range of 200-800 nm, such as about 300-500 nm. Such DLIP can also create both microstructures and nanostructures without significantly thermally altering the surface 214 (e.g., without significant amounts of melted material deposits).

In an example, the system controller 215 can control movement of the laser 204 or the metal substrate 110 with respect to each other. The system controller 215 can control the laser 204 (such as position, beam parameters, etc.) generate cavities in the metal substrate 110. The system controller 215 can control a plurality of variables, such as the distance d between the optical prism 216 and the DOE 218, laser wavelength, etc. and also can control mean laser power, drilling time, and pitch.

By employing linear polarization and low fluence e.g., via an ultrashort pulsed laser, the formation of ripples, known as LIPSS, can be achieved. Such ripples are oriented perpendicular to the light polarization and exhibit periodic nanotextures. These nanotextures, characterized by high spatial frequency LIPSS (HSFL) and low spatial frequency LIPSS (LSFL), can establish antibacterial properties on the metal substrate 110 and enhance an adhesion of Human Mesenchymal Stem Cells. Also, surface modification of the metal substrate via an ultrashort pulsed laser can significantly reduce biofilm formation. For example, a period of the LSFL can fall slightly below the wavelength, and texture sizes similar to those of bacteria restrict their contact points, resulting in a decrease in bacterial adhesion to the surface. In an example, by transitioning from a laser having an infrared wavelength to a laser having a green wavelength, a period of less than 500 nm can be established on the substrate 110, which can further promote antibacterial characteristics of the surface 114 of the substrate 110.

In an example, the system 202 can facilitate either of Laser-Induced Periodic Surface Structures (LIPSS) or nano-patterns on the metal substrate 110. For example, the metal substrate 110 can be affected via the laser 204 to produce nano-patterns, such as via manipulation of an ultrashort pulse beam, which was bifurcated into two separate beams (e.g., using a birefringent crystal (e.g., formed of CaCO3, about 41 mm long, such as Thorlabs ref. BD40)) with a controlled delay of about 23 picoseconds (ps). In an example, under low fluence conditions (e.g., below about 0.5 J/cm²), a sequential delivery of these pulses can establish a formation of a distinct nano-pattern characterized by dimensions substantially similar to (e.g., within about 10% of) LIPSS. However, the shape of such nano-patterns can exhibit triangular or plot-like morphology, different from a morphology of LIPSS. In an example, forming sub-micrometer textures can help limit the possible contact points of rod-shaped cells such as E. coli cells.

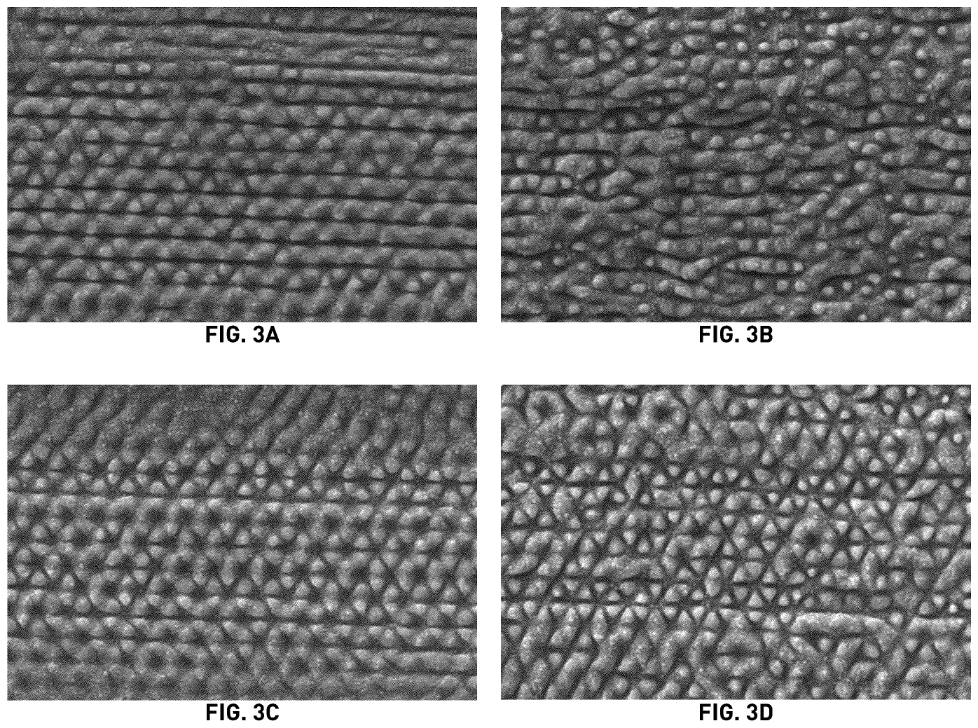

FIG. 3A, FIG. 3B, FIG. 3C, and FIG. 3D each illustrate an electron microscope view of a laser-induced nanopattern on an exemplary stainless steel substrate. In an example, crossed polarization can establish enhanced textures in a target substrate including sharper details (as compared with linear polarization), such as resulting in a relatively higher shots per area (SPA) while establishing Triangular Nano-Patterns (TNP) on the substrate. For example, crossed polarization can form of TNPs with dimensions smaller than the incident wavelength, e.g., when exposed to relatively low fluence and dose levels. The TNP exhibit HSFL features positioned between each triangle (with period below half the wavelength), without requiring any discernible preferred orientation (as shown in FIG. 3A). As a total dose is incrementally increased, the TNP transitions toward larger structures, accompanied by the partial disappearance of HSFL patterns (as shown in FIG. 3B). When circular polarization is employed along with low fluence, the nanotextures exhibit analogous triangular patterns and HSFL features as observed with crossed polarization (as shown in FIG. 3C). Notably, the TNP can remain visible even at relatively higher doses (as shown in FIG. 3D), such as exhibiting the structures with greater depth while retaining the presence of HSFL.

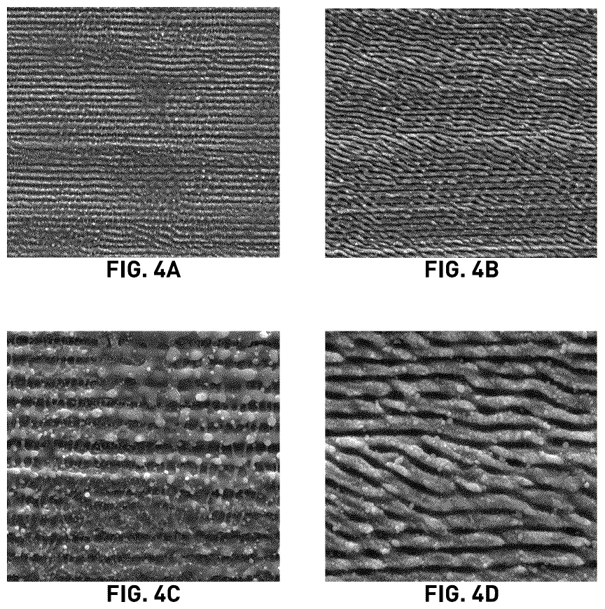

FIG. 4A, FIG. 4B, FIG. 4C, and FIG. 4D each illustrate an electron microscope view of a nanotextured surface of an exemplary stainless steel substrate. LIPSS is a phenomenon where, under ultrashort pulse and linear polarization of a laser beam, a surface plasmon is generated onto the sample's surface resulting in a periodic pattern. The orientation of this pattern can be perpendicular to the direction of the light polarization. In an example, LIPSS can be induced via an infrared laser (e.g., at about 1030 nm). At a relatively low fluence and dose, Low Spatial Frequency LIPSS (LSFL) can be formed perpendicular to the polarization and High Spatial Frequency LIPSS (HSFL) parallel to the polarization (as shown in FIG. 4A and FIG. 4C). In infrared irradiation, the LSFL structures manifest with a period shorter than the incident wavelength (e.g., at about 800 nm), whereas the HSFL structures can exhibit a period lower than half the wavelength (e.g., at about 450 nm). Upon maintaining the same fluence while incrementing the total dose, notable transformations are observed (as shown in FIG. 4B and FIG. 4D). For example, the LSFL structures can deviate from their approximately linear nature, resulting in profiles that possess increased depth and more expansive plots. Such conditions can even cause certain HSFL structures to disappear.

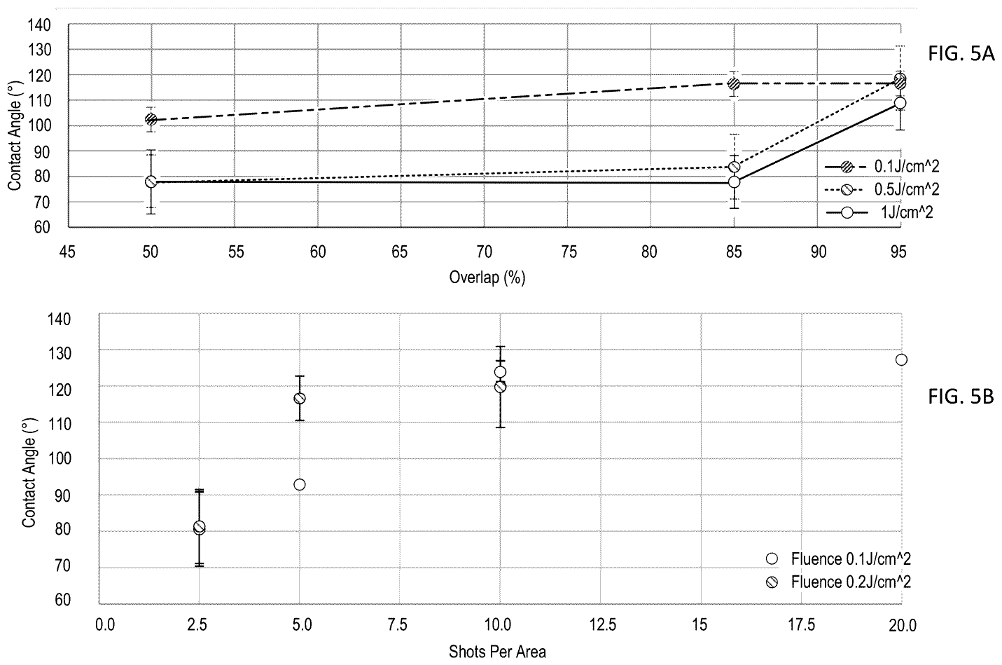

FIG. 5A is a chart showing a relationship between contact angle and laser induced periodic surface structure (LIPSS) overlap. Geometric attributes of the textures can play a direct role in determining the contact angle. For example, as a fluence and overlap are augmented, the contact angle can be observed to increase. Consequently, augmenting the total dose delivered to the samples can give rise to hydrophobic nanotextured surfaces, further accentuating their hydrophobic characteristics.

FIG. 5B is a chart showing a relationship between contact angle and laser induced periodic surface structure (LIPSS) shots per area (SPA). FIG. 5B demonstrates a correlation between the nanotexture's morphology and the number of SPA, which can be directly linked to the total dose delivered to the material. Notably, TNPs can be induced at relatively lower fluences (e.g., ranging from about 0.1 J/cm² to about 0.2 J/cm² when employing SPA of about 10). However, as the SPA value increased, the nanotexture can shift from nanopatterns toward larger structures. Concurrently, the contact angle can exhibit an upward trend with increasing SPA values. In an example, there can be no substantial increase in the contact angle observed for SPA values ranging from 1 to 5. Conversely, a notably higher contact angle can be observed for SPA values exceeding 10. In an example involving circular polarization instead of crossed linear polarization, the nanotexture shape can remain unaltered at relatively low fluences. However, at higher SPA values and doses, circular polarization can yield improved homogeneity in TNP.

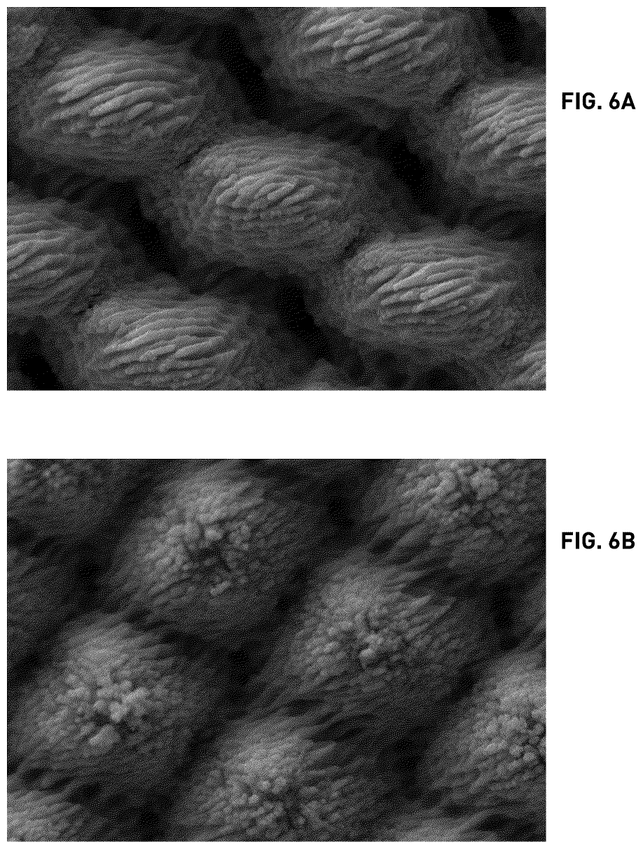

FIG. 6A illustrates an electron microscope view of at least a microtextured surface of an exemplary stainless steel substrate. Here, direct laser interference patterns DLIPs can be superimposed on an existing microstructure, such as via a single beam-split laser. Such a configuration can result in surface properties of self-cleaning and preventing biofilm formation on a metal substrate. When performing a cross-hatch at about 90 degrees and relatively low fluence of (e.g., about 0.137 J/cm²), a pattern on a metal substrate can be produced including microstructures (e.g., spikes spanning several micrometers) with LIPSS stripes on top of the spikes. Such LIPSS increments can be produced at an interval between about 400 nm and 600 nm, such as at an interval of about 450 nm or 500 nm.

FIG. 6B illustrates an electron microscope view of a microtextured and nanotextured surface of an exemplary stainless steel substrate. Here, a laser in having an infrared wavelength can induce LIPSS or TNPs, which can be superimposed on an existing microstructure. Such a configuration can result in surface properties of self-cleaning and preventing biofilm formation on a metal substrate. As shown in FIG. 6B, under relatively low fluence of (e.g., about 0.137 J/cm²), nanoparticles can be overlayed atop of the micro-structures while LIPSS can be formed in the “valleys” between the microstructures.

FIG. 7 is a flowchart showing an example of a protocol for passivation of a stainless steel surface. As described above with respect to FIG. 1C, laser treated substrates can generally be subject to ambient conditions for a period up to about 60 days, such as to promote passivation leading to a growth of hydrocarbons and oxidized metal species on the surface of the treated substrate. Alternatively or additionally, the metal substrate described with respect to any of FIG. 1A, FIG. 1B, FIG. 1C, FIG. 2A, FIG. 2B, FIG. 2C, FIG. 3A, FIG. 3B, FIG. 3C, FIG. 3D, FIG. 4A, FIG. 4B, FIG. 4C, FIG. 4D, FIG. 6A, or FIG. 6B can be treated via chemical passivation following the laser treatment.

For example, at 701, a liquid detergent can be applied to a laser treated substrate. For example, the liquid detergent can include STERIS® Prolystica Restore® concentrate at a concentration of about 20 milliliters per liter (mL/L), such as 6 mL of Prolystica Restore® in a solution of tap water. In an example, the laser treated substrate can be immersed in the liquid detergent with a laser treated side facing upwards. In an example, the liquid detergent can include at least one of citric acid and oxalic acid. In an example, the liquid detergent can include sodium xylene sulfonate. In an example, the liquid detergent can be applied to the laser treated substrate without additional application of nitric acid, fluoride, sulfur, or phosphorous.

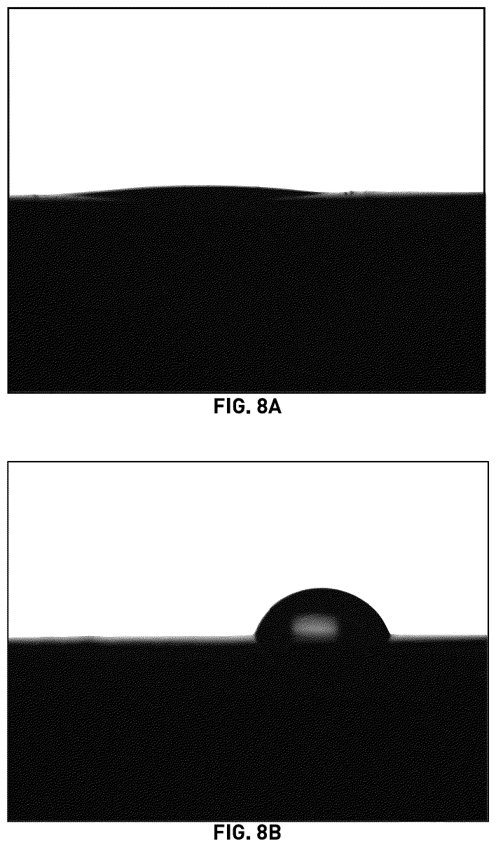

At 702, heat can be applied to the laser-treated substrate during immersion in the liquid detergent. For example, the heat can be applied via a hot plate to reach a temperature greater than about 80° C., such as toward a target temperature of about 90° C. In an example, a thermocouple can be immersed in the liquid detergent to monitor a temperature thereof. The heat can be applied for greater than 30 minutes, such as for about 40 minutes, and the temperature can be modulated from about 19° C. toward about 91° C. In an example, a target temperature can be maintained (such as within about 5% of the target temperature) for less than five hours (e.g., about two hours). In an example, the laser treated substrate can remain in the liquid detergent following the heating and during cooling down following the heating. FIG. 8A illustrates an example of a laser-induced stainless steel surface prior to the chemical passivation described in FIG. 7, and FIG. 8B illustrates the surface following the chemical passivation. The chemical passivation can result in a change from a surface of the laser treated substrate being hydrophilic (contact angle of less than about) 30° to the laser treated substrate being hydrophobic or superhydrophobic (contact angle of greater than) 40°. For example, the chemical passivation can result in the contact angle of the laser-treated surface being greater than about 70°, such as a contact angle of about 75.5°. In an example, the chemical passivation can result in a greater contact angle greater than 80°.

Optionally, at 703, each of operations 701 and 702 can be repeated in sequence to help maintain or restore a substantially hydrophobic property to the laser treated surface over time. For example, internal surfaces of a medical device can be flooded with the liquid detergent and a heating element can heat the liquid detergent according to the parameters described above with respect to 901 and Prepare Substrate for Laser Treatment 901. Such recurring chemical passivation can help promote longevity of a medical device including antibacterial, laser-treated surfaces.

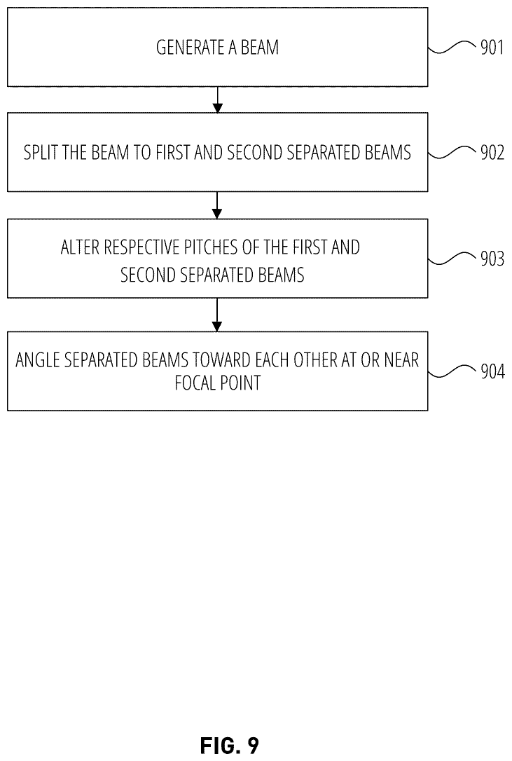

FIG. 9 is a flowchart describing a process for treating a stainless steel substrate. The process involves a sequence of operations executed through laser irradiation, chemical passivation, and maintenance protocols.

At 901, a single laser beam can be generated having specified parameters including a pulse duration less than 800 femtoseconds (fs) and a wavelength greater than 700 nanometers (nm). For example, the pulse duration of the beam can be about 450 fs and the wavelength can be about 1032 nm.

At 902, the generated beam can encounter a diffractive optical element (DOE), which splits the single beam into first and second separated beams. These separated beams are configured to angle away from each other after passing through the DOE. The distance between the optical prism and the DOE can be established or adjusted to achieve both a specified incidental angle at which the separated beams are received by the focal lens and a specified interval of distance between each of the plurality of microstructures.

At 903, following the beam splitting, an optical prism receives the separated beams and alters their respective pitches. The optical prism may be formed of fused silica and configured as a triangular prism having a largest angle within a range of 150° to about 170°.

At 904, the altered beams can proceed toward a focal lens, which receives both separated beams and angles them toward each other. The focal lens directs the beams to converge at or near a single focal point on the metal substrate. When the altered, separated beams combine at the focal point, their combined laser irradiation affects the metal substrate in a specific way. This combined irradiation concurrently forms both a plurality of microstructures and a plurality of nanostructures on the substrate surface. The microstructures are formed with specific dimensions, defining a depth in the metal substrate within a range of 5 to 15 micrometers and having a width within a range of 20 to 150 micrometers. The nanostructures are formed with depths ranging from 5 to 100 nanometers (nm) and widths within a range of 100 to 800 nm.

In an example, following the laser treatment, the metal substrate can undergo a passivation process (e.g., similar to that described with respect to FIG. 7) to alter its properties from hydrophilic to hydrophobic, establishing a contact angle greater than 70 degrees on the metal substrate. The passivation process involves chemical passivation through the application of a liquid detergent. This detergent may contain specific components such as citric acid, oxalic acid, and sodium xylene sulfonate. The chemical passivation can form an oxide layer on the metal substrate.

The passivation process can also include applying the liquid detergent and heat for less than five hours, notably without the application of nitric acid, fluoride, sulfur, or phosphorous. To maintain the hydrophobic property over time, the liquid detergent and heat may be recurringly applied to the metal substrate.

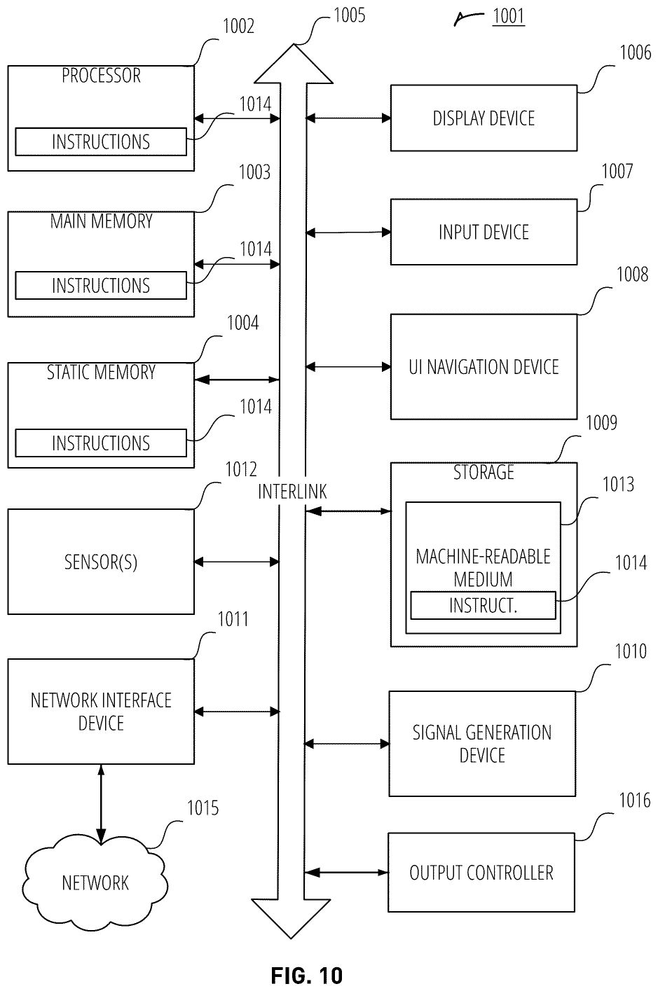

FIG. 10 illustrates an example of a block diagram of a machine 1001 upon which any one or more of the techniques (e.g., methodologies) discussed herein may perform in accordance with some examples. For example, the machine 1001 could be used to operate the laser 204 of FIG. 2A or sensors related to the laser 204. Further, the machine 1001 could be used to help facilitate the manufacturing processes of the affecting of a metal substrate, chemical passivating of the metal substrate, maintenance of the metal substrate via recurring passivation, or a verification process corresponding to the chemical passivating. In alternative embodiments, the machine 1001 may operate as a standalone device or may be connected (e.g., networked) to other machines. In a networked deployment, the machine 1001 may operate in the capacity of a server machine, a client machine, or both in server-client network environments. In an example, the machine 1001 may act as a peer machine in peer-to-peer (P2P) (or other distributed) network environment. The machine 1001 may be a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms in an electronic implementation of the machine 1001. Such components may be provided by circuitry (e.g., processing circuitry) that is a collection of circuits implemented in tangible entities of the machine 1001 that include hardware (e.g., simple circuits, gates, logic, etc.). Circuitry membership may be flexible over time. Circuitry can include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, circuits, etc.) including a machine readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice-versa. The instructions can enable embedded hardware (e.g., the execution units or a loading mechanism) to create members of the circuitry in hardware via the variable connections to carry out portions of the specific operation when in operation. Accordingly, in an example, the machine readable medium elements are part of the circuitry or are communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time. Additional examples of these components with respect to the machine 1001 follow.

Machine (e.g., computer system) 1001 may include a hardware processor 1002 (e.g., a central processing unit (CPU), a graphics processing unit (GPU), a hardware processor core, or any combination thereof), a main memory 1003 and a static memory 1004, some or all of which may communicate with each other via an interlink (e.g., bus) 1005. The machine 1001 may further include a display unit 1006, an alphanumeric input device 1007 (e.g., a keyboard), and a user interface (UI) navigation device 1008 (e.g., a mouse). In an example, the display unit 1006, alphanumeric input device 1007 and UI navigation device 1008 may be a touch screen display. The machine 1001 may additionally include a storage device (e.g., drive unit) 1009, a signal generation device 1010 (e.g., a speaker), a network interface device 1011, and one or more sensors 1012, such as a global positioning system (GPS) sensor, compass, accelerometer, or another sensor. The machine 1001 may include an output controller 1016, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1009 may include a machine readable medium 1013 that is non-transitory on which is stored one or more sets of data structures or instructions 1014 (e.g., software) embodying or utilized by any one or more of the techniques or functions described herein. The instructions 1014 may also reside, completely or at least partially, within the main memory 1003, within static memory 1004, or within the hardware processor 1002 during execution thereof by the machine 1001. In an example, one or any combination of the hardware processor 1002, the main memory 1003, the static memory 1004, or the storage device 1009 may constitute machine readable media.

While the machine readable medium 1013 is illustrated as a single medium, the term “machine readable medium” may include a single medium or multiple media (e.g., a centralized or distributed database, or associated caches and servers) configured to store the one or more instructions 1014.

The term “machine readable medium” may include any medium that is capable of storing, encoding, or carrying instructions for execution by the machine 1001 and that cause the machine 1001 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1014 may further be transmitted or received over a communications network 1015 using a transmission medium via the network interface device 1011 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®), IEEE 802.15.4 family of standards, peer-to-peer (P2P) networks, among others. In an example, the network interface device 1011 may include one or more physical jacks (e.g., Ethernet, coaxial, or phone jacks) or one or more antennas to connect to the communications network 1015. In an example, the network interface device 1011 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 1001, and includes digital or analog communications signals or other intangible medium to facilitate communication of such software.

The following, non-limiting examples, detail certain aspects of the present subject matter to solve the challenges and provide the benefits discussed herein, among others.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The following, non-limiting examples, detail certain aspects of the present subject matter to solve the challenges and provide the benefits discussed herein, among others.

Example 1 is a method for treating a metal substrate, the method comprising: generating a beam from a single laser, the beam having a pulse duration less than eight hundred femtoseconds and a wavelength greater than seven hundred nanometers (nm); splitting the beam via a diffractive optical element (DOE), establishing first and second separated beams angled away from each other; altering, via an optical prism, respective pitches of the first and second separated beams via an optical prism; and receiving, via a focal lens, the altered first and second separated beams to angle the separated beams toward each other at or near a single focal point on a metal substrate; wherein a combined laser irradiation from the altered, separated beams affects the metal substrate to concurrently form a plurality of microstructures and a plurality of nanostructures thereon.

In Example 2, the subject matter of Example 1 includes, establishing or adjusting a distance between the optical prism and the DOE toward a specified incidental angle the separated beams are received by the focal lens and a specified interval of distance between each of the plurality of microstructures.

In Example 3, the subject matter of Examples 1-2 includes, passivating the formed metal substrate to alter a metal substrate property from hydrophilic to hydrophobic.

In Example 4, the subject matter of Example 3 includes, wherein the passivating establishes a contact angle greater than seventy degrees on the metal substrate.

In Example 5, the subject matter of Examples 1˜4 includes, wherein the laser irradiation affects the metal substrate such that each of the plurality of microstructures define a depth in the metal substrate within a range of five to fifteen micrometers and have a width within a range of twenty to one hundred fifty micrometers.

In Example 6, the subject matter of Examples 1-5 includes, wherein the laser irradiation affects the metal substrate such that each of the plurality of nanostructures define depth of the substrate in a range of five to one hundred nanometers (nm) and have a width within a range of one hundred to eight hundred nm.

In Example 7, the subject matter of Examples 1-6 includes, wherein the microstructures comprise a width larger than ten micrometers.

In Example 8, the subject matter of Examples 1-7 includes, wherein the nanostructures comprise a width smaller than one micrometer.

In Example 9, the subject matter of Examples 3-8 includes, wherein the passivating is chemical passivation including application of a liquid detergent.

In Example 10, the subject matter of Example 9 includes, wherein the chemical passivation forms an oxide layer on the metal substrate.

In Example 11, the subject matter of Examples 9-10 includes, wherein the liquid detergent comprises citric acid and oxalic acid.

In Example 12, the subject matter of Examples 9-11 includes, wherein the liquid detergent comprises sodium xylene sulfonate.

In Example 13, the subject matter of Examples 9-12 includes, wherein the passivating of the metal substrate consists of applying the liquid detergent and heat for less than five hours.

In Example 14, the subject matter of Examples 9-13 includes, recurringly applying liquid detergent and heat to the metal substrate and to maintain the hydrophobic property over time.

In Example 15, the subject matter of Examples 9-14 includes, wherein the passivating consists of applying the liquid detergent and heat without application of nitric acid, fluoride, sulfur, or phosphorous.

Example 16 is a laser-inscribed, hydrophobic stainless steel substrate obtained according to a process which comprises: generating a beam from a single laser, the beam having a pulse duration less than eight hundred femtoseconds and a wavelength greater than seven hundred nanometers (nm); splitting the beam via a diffractive optical element (DOE), establishing first and second separated beams angled away from each other; altering, via an optical prism, respective pitches of the first and second separated beams via an optical prism; and receiving, via a focal lens, the altered first and second separated beams to angle the separated beams toward each other at or near a single focal point on a metal substrate; wherein a combined laser irradiation from the altered, separated beams affects the metal substrate to concurrently form a plurality of microstructures and a plurality of nanostructures thereon.

In Example 17, the subject matter of Example 16 includes, wherein the process further comprises passivating the formed metal substrate to alter a metal substrate property from hydrophilic to hydrophobic.

Example 18 is an apparatus for treating a metal substrate, the apparatus comprising: a laser configured to generate a single beam having a pulse duration less than eight hundred femtoseconds and a wavelength greater than seven hundred nanometers (nm); a diffractive optical element (DOE) arranged to split the single beam into first and second separated beams angled away from each other; an optical prism arranged to alter respective pitches of the first and second separated beams; and a focal lens arranged to angle the first and second separated beams toward each other at or near a single focal point on a metal substrate; wherein a combined laser irradiation from the altered, separated beams affects the metal substrate to concurrently form a plurality of microstructures and a plurality of nanostructures thereon.

In Example 19, the subject matter of Example 18 includes, a prism manipulator configured to adjusting a distance between the optical prism and the DOE and user-controllable to establish or adjust an incidental angle the separated beams are received by the focal lens and an interval of distance between each of the plurality of microstructures.

In Example 20, the subject matter of Examples 18-19 includes, wherein the optical prism is a triangular prism having a largest angle within a range of one hundred fifty degrees to about one hundred seventy degrees.

In Example 21, the subject matter of Examples 18-20 includes, wherein the optical prism is formed of fused silica.

Example 22 is at least one machine-readable medium including instructions that, when executed by processing circuitry, cause the processing circuitry to perform operations to implement of any of Examples 1-21.

Example 23 is an apparatus comprising means to implement of any of Examples 1-21.

Example 24 is a system to implement of any of Examples 1-21.

Example 25 is a method to implement of any of Examples 1-21.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for treating a metal substrate, the method comprising:
generating a beam from a single laser, the beam having a pulse duration less than 800 femtoseconds and a wavelength greater than 700 nanometers (nm);
splitting the beam via a diffractive optical element (DOE), establishing first and second separated beams angled away from each other;
altering, via an optical prism, respective pitches of the first and second separated beams; and
receiving, via a focal lens, the altered first and second separated beams to angle the separated beams toward each other at or near a single focal point on a metal substrate;
wherein a combined laser irradiation from the altered, separated beams affects the metal substrate to concurrently form a plurality of microstructures and a plurality of nanostructures thereon.

2. The method of claim 1, comprising establishing or adjusting a distance between the optical prism and the DOE toward a specified incidental angle, wherein the separated beams are received by the focal lens and a specified interval of distance between each of the plurality of microstructures.

3. The method of claim 1, comprising passivating the formed metal substrate to alter a metal substrate property from hydrophilic to hydrophobic.

4. The method of claim 3, wherein the passivating establishes a contact angle greater than 70 degrees on the metal substrate.

5. The method of claim 1, wherein the laser irradiation affects the metal substrate such that each of the plurality of microstructures define a depth in the metal substrate within a range of 5 to 15 micrometers and have a width within a range of 20 to 150 micrometers.

6. The method of claim 1, wherein the laser irradiation affects the metal substrate such that each of the plurality of nanostructures define depth of the substrate in a range of 5 to 100 nanometers (nm) and have a width within a range of 100 to 800 nm.

7. The method of claim 1, wherein the microstructures comprise a width larger than 10 micrometers.

8. The method of claim 1, wherein the nanostructures comprise a width smaller than 1 micrometer.

9. The method of claim 3, wherein the passivating is chemical passivation including application of a liquid detergent.

10. The method of claim 9, wherein the chemical passivation forms an oxide layer on the metal substrate.

11. The method of claim 9, wherein the liquid detergent comprises citric acid and oxalic acid.

12. The method of claim 9, wherein the liquid detergent comprises sodium xylene sulfonate.

13. The method of claim 9, wherein the passivating of the metal substrate consists of applying the liquid detergent and heat for less than five hours.

14. The method of claim 9, comprising recurringly applying liquid detergent and heat to the metal substrate and to maintain the hydrophobic property over time.

15. The method of claim 9, wherein the passivating consists of applying the liquid detergent and heat without application of nitric acid, fluoride, sulfur, or phosphorous.

16. A laser-inscribed, hydrophobic stainless steel substrate obtained according to a process which comprises:
generating a beam from a single laser, the beam having a pulse duration less than 800 femtoseconds and a wavelength greater than 700 nanometers (nm);
splitting the beam via a diffractive optical element (DOE), establishing first and second separated beams angled away from each other;
altering, via an optical prism, respective pitches of the first and second separated beams; and
receiving, via a focal lens, the altered first and second separated beams to angle the separated beams toward each other at or near a single focal point on a metal substrate;
wherein a combined laser irradiation from the altered, separated beams affects the metal substrate to concurrently form a plurality of microstructures and a plurality of nanostructures thereon.

17. The laser-inscribed, hydrophobic stainless steel substrate of claim 16,
wherein the process further comprises passivating the formed metal substrate to alter a metal substrate property from hydrophilic to hydrophobic.

18. An apparatus for treating a metal substrate, the apparatus comprising:
a laser configured to generate a single beam having a pulse duration less than 800 femtoseconds and a wavelength greater than 700 nanometers (nm);
a diffractive optical element (DOE) arranged to split the single beam into first and second separated beams angled away from each other;
an optical prism arranged to alter respective pitches of the first and second separated beams; and
a focal lens arranged to angle the first and second separated beams toward each other at or near a single focal point on a metal substrate;
wherein a combined laser irradiation from the altered, separated beams affects the metal substrate to concurrently form a plurality of microstructures and a plurality of nanostructures thereon.

19. The apparatus of claim 18, comprising a prism manipulator configured to adjust a distance between the optical prism and the DOE and user-controllable to establish or adjust an incidental angle, wherein the separated beams are received by the focal lens and an interval of distance between each of the plurality of microstructures.

20. The apparatus of claim 18, wherein the optical prism is a triangular prism having a largest angle within a range of 150° to about 170°.

21. The apparatus of claim 18, wherein the optical prism is formed of fused silica.
